(19) United States
(12) Patent Application Publication
(10) Pub. No.: US 2022/0198595 A1
(43) Pub. Date: Jun. 23, 2022

(54) Mobile Transaction Offer/Acceptance Model

(71) Applicants: SANJIV OBEROI, WEST HEMPSTEAD, NY (US); VIKRAM MALIK, BALDWIN, NY (US)

(72) Inventors: SANJIV OBEROI, WEST HEMPSTEAD, NY (US); VIKRAM MALIK, BALDWIN, NY (US)

(21) Appl. No.: 17/038,268

(22) Filed: Sep. 30, 2020

(51) Int. Cl. G06Q 50/18; G06Q 30/02

(52) U.S. Cl. CPC G06Q 50/188; G06Q 30/0239

(57) ABSTRACT

Discussed herein is a server-implemented negotiation framework with mobile devices as nodes negotiating on pricing of services. This negotiation is done in real time using wireless networks for communication using mobile devices. There are three types of end-nodes, that will be involved in the negotiation using digital communication. First type of node is a Server—an individual node, second is requestor node—an individual node, and the third type of node is responder(s) or service provider(s)—potentially multiple nodes responding and communicating with the requestor node. Transaction starts with the requestor mode initiating a service request. Server receives the request and compiles a list of potential responders based on a set of criteria beneficial to both requestor and responders. The list of potential responders is prioritized based on the service criteria. Server broadcasts the service request to potential responders based on the generated list of potential responders. Any of the responder node can acknowledge and respond to the service request with an offer of discount for service. Discounted offer for the service is presented to the requestor node. At this point requestor makes the selection from the given set of offers. As the requestor confirms accepting the discounted offer, the selected responder is notified, and a connection is made, service and discounted price agreeable to the requestor and responder. All communications are mediated via the server, making the connection. Negotiating and connecting service requestor to multiple potential service providers improves purchasing decision-making and empower better deals for all parties with minimal effort.

This invention relates to the offer of service, and subsequent offer of discounts on the service by the service providers, and finally acceptance of offer by the service requestor.

All the interactions are handled via mobile devices, with a server orchestrating the communication, and using artificial intelligence on using past service as data points, and additional information about the service providers to identify the optimal list of service provider.

### BACKGROUND OF THE INVENTION

There are numerous outlets for purchasing services, like ride sharing, by individuals or companies. However, the current way to obtain services is very tedious and cumbersome for a price contentious customer. Currently, a person looking for a service, performs tedious activities to find the service provider and the best price for the service.

Especially when looking for a ride sharing service, a person or group looking for a car ride from one place to another has many options. Instead of riders looking for the best way to get a ride share, we can have the rider just identify their travel needs, and drivers can compete for getting their business. When the riders are looking for a ride sharing service, they are not certain they are getting the best discounted prices.

### SUMMARY OF THE INVENTION

The disclosed examples are described with detail below with reference to the accompanying drawing figures listed below.

The following summary is provided to illustrate some examples disclosed herein, and is not meant to necessarily limit all examples to any particular configuration or sequence of operations.

Some examples are directed to a framework in which artificial intelligence (AI) listing agents (otherwise known as robots or “bots”) on the server are used to identify and organize the optimal list of car ride sharing service providers and present the service details, and discounted offer terms for the drivers.

Additionally, driver has the option to accept the discount offer suggested, or offer further discounts in order to acquire business. Riders for the car sharing service will specify the particular of the ride sharing need, and the listing agent identifies the list of drivers, and suggested discount terms for the drivers.

The listing AI agent is aware of the rider's budget, needs, and travel patterns along and matches the rider with matching details about the potential available drivers.

This AI based matching of rider with potential drivers result in better deals for the rider, and driver. Identified drivers in the order identified by the listing agent bots, get notified of the request from a rider.

Driver has the option to respond to the request by accepting the suggested discounts, or further offer deeper discount to the rider. Driver availability and offered discounts are communicated to the rider.

Rider has the option to view all the responses from the drivers.

Rider does the final selection, and upon acceptance of ride sharing particulars and ride sharing discount, the selected driver is informed and a connection is setup between the rider and driver.

### BRIEF DESCRIPTION OF DIAGRAMS

The disclosed examples are described in detail below with reference to the accompanying drawing figures listed below:

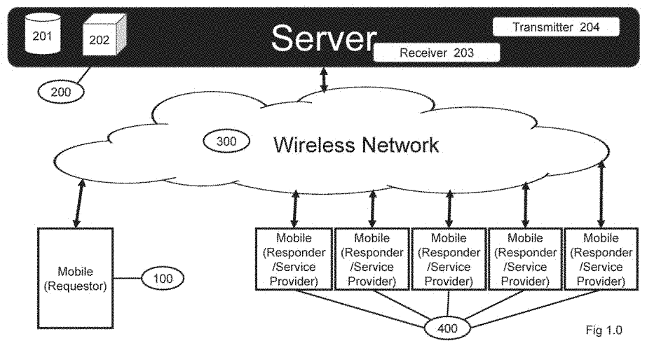

FIG. 1.0—are exemplary block diagrams illustrating computing devices & networking environment in the implementation of the Offer/Acceptance model

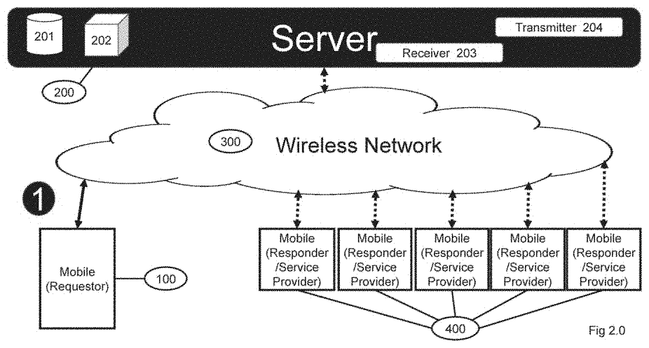

FIG. 2.0—are exemplary block diagrams illustrating the initiation of request for service

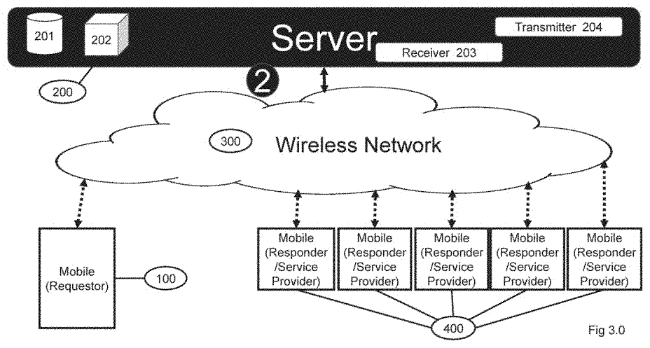

FIG. 3.0—are exemplary block diagrams illustrating the server receiving the request, and using Listing agent to identify the potential responders for the request

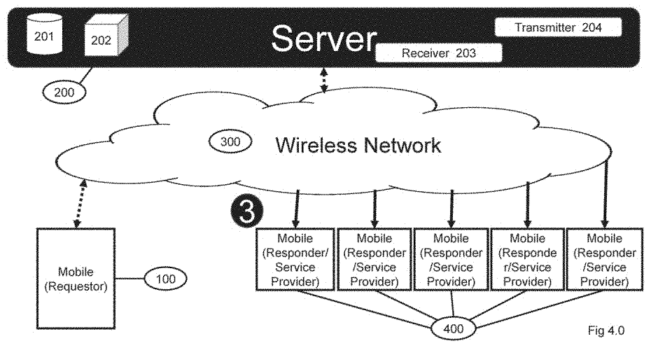

FIG. 4.0—are exemplary block diagrams illustrating the broadcasting of request to the potential responders identified by the listing agent on the server

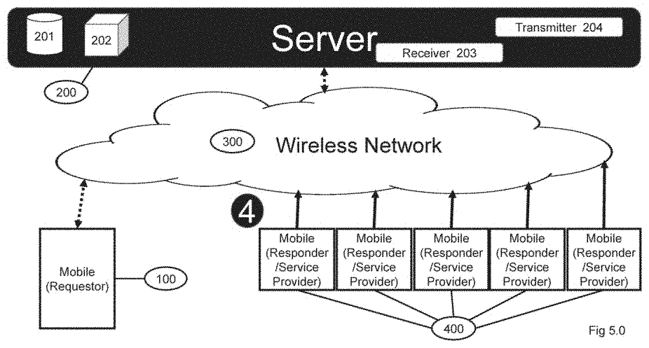

FIG. 5.0—are exemplary block diagrams illustrating the response from the responders in terms of the discounts they can offer

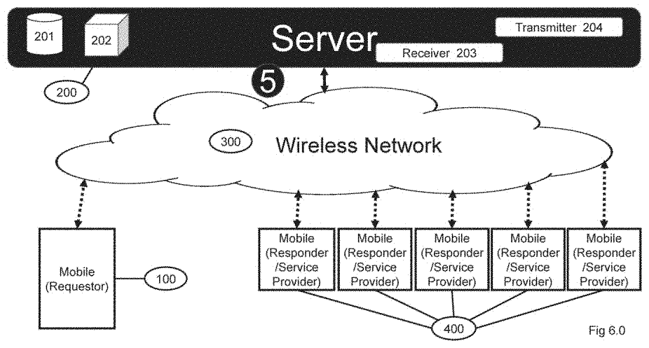

FIG. 6.0—are exemplary block diagrams illustrating the server listing agent accumulating and processing the response of discounts offered to the person requesting the service

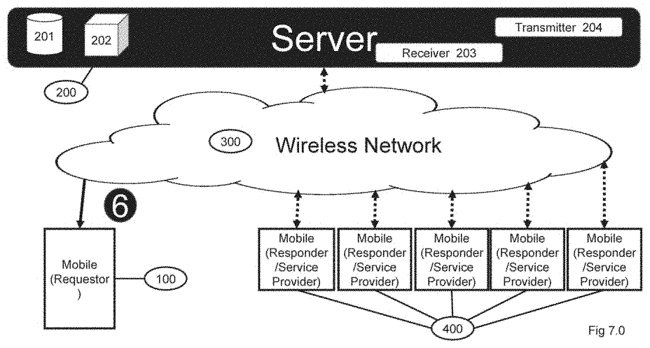

FIG. 7.0—are exemplary block diagrams illustrating the server sending the discounts available to the requestor node

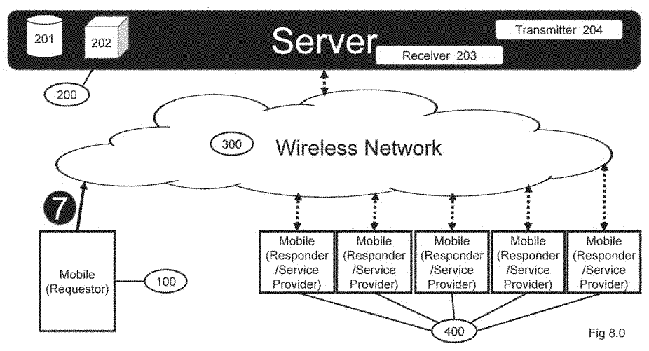

FIG. 8.0—are exemplary block diagrams illustrating the selection of the offer from the requestor to the server

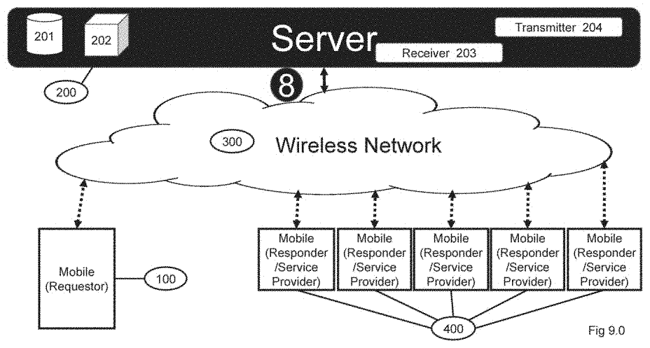

FIG. 9.0—are exemplary block diagrams illustrating the server processing the selection of service by the requestor, and preparing to setup the connection

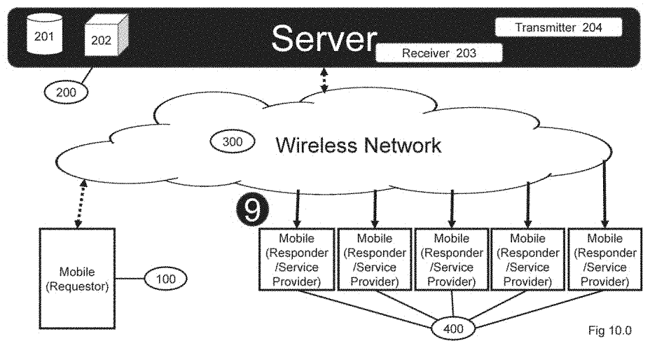

FIG. 10.0—are exemplary block diagrams illustrating the server confirming the service providers if their offer was accepted, and forming the connection between the requestor of service and the selected service provider

### DETAILED DESCRIPTION

The examples disclosed herein generally relate to an Artificial Intelligence (AI) powered framework whereby autonomous AI agents will respond and form an Offer/Acceptance model for the service requestor and service provider.

The requestor and provider communicate using the disclosed framework in an optimized and controlled way that allows various aspects of the offer/acceptance to be adjusted nearly instantly.

The disclosed framework herein is setup for requestor and responders to utilize mobile devices for communication with the server.

Server 200 is running the AI based finder service, identifying and facilitating the connection between the service requestor and service providers—benefiting both parties.

Server 200 is a hardware hosting database, and multiple processing modules, accessible to service requestor and service provider via a wireless network.

A transaction starts when a node working as a requestor, sends a request for service. All service particulars are communicated to the server.

Embodiment of the present invention provide a system and method for offer of service, and terms of service agreement for service requestor and service providers.

In an embodiment, an automated system using artificial intelligence will identify the potential service providers, for a service request.

This offer of service by potential service providers and discounts they can offer are presented to the service requestor, who will select the service provider that will fulfill their needs for the service.

One embodiment includes an automated system using artificial intelligence to act as the receptor of initial request by the service requestor, identify the optimal list of potential service providers using the information about the service requestor, and patterns of service by the service providers.

This embodiment will transmit the request to the identified list of service providers. Service providers can respond with the discounts they can offer, as their terms of service.

This embodiment will transmit the offers from the service providers to the service requestor, who will have the option to select an offer for service. When the service requestor selects a service offering, the selected service provider is notified, and an offer-acceptance agreement is set.

FIG. 1.0 illustrates a schematic diagram of a system, inclusive of all node involved in the offer and acceptance model.

First node (100) is the node where service request is originated.

Node 100 could be any form of mobile device, it is connected to a communication network, such as the internet (300).

Connection between 100 and 300 will be wireless and may operate using one or more protocols known in the art, such as TCP/IP, WLAN, LAN, and/or Wi-Fi 802.11 a-n, for example.

Server (200) may allow the service requestor and potential service providers (400) to connect through the communication network.

Request originator 100 displays user interface, websites, applications or other software that provides connectivity to Server 200.

One embodiment 200 includes an automated and based on artificial intelligence to identify the optimal and potential service providers for the service request.

Embodiment 200 also acts as the mediator of all communications between service requestor 100 and potential service providers 400.

As 200 identifies the list of optimal and service providers which will result in biggest discount for the service requestor, the service request is communicated to the list of potential service providers.

It is broadcasted in batches of 5 service providers.

The broadcasting of service request to the potential service providers is arranged in the order identified by 200, such that, the broadcast will result in fastest turn around and deeper discounts for the service providers.

Embodiment will wait to gather at least responses from 3 service providers before presenting the offer to the service requestor. Server embodiment 200 will send the service request to first 5 service providers, and then it passes the service request to next 5 potential service providers from the list of identified service providers.

This broadcasting to potential service providers continues until at least responses from 3 service providers, or a pre-defined time to respond expires.

All responses received from the service providers are presented to the service requestor in the order of high to low value to the service requestor.

Service requestor selects an offer from the displayed offers, and this information is communicated to server 200, which in turn passes the information to the selected service provider, so they can execute on the agreement.

Server 200 may include service criteria database 201 which may be used to determine the list of optimal service provider to service the request by the service requestor.

Additionally, server 200 will utilize the existing application programming interfaces (API) available to help compute a baseline pricing for the service request.

Database 201 will store and utilize information about the service requestor, and service providers, including the patterns of service requested and accepted by the service requestor as well as the pattern of offers from the service providers.

Information in the database 201 may contain service requestor details such as, but not limited to, requestor personal information, contact information and financial information including preferred method of payment.

Database 201 may include service provider data, the patterns of offer generated by the service provider including frequency of service request acceptance, and level of discounts offered by the service providers.

Server 200 of FIG. 1.0 may include an automated finder module 202, this module will utilize artificial intelligence-based information in database 201 to generate the list of optimal potential service providers.

Server 200 of FIG. 1.0 may include a receiver 203 module, this module will manage all communications from service requestor 100 as well as service providers 400.

The receiver module is responsible for listening too, receiving, and processing the message received by the module.

Server 200 of FIG. 1.0 may include a transmitter 204 module, this module is responsible for transmitting any/all communications to service requestor 100, as well as service providers 400.

Transmitter module will keep track of all threads of service request and service providers communication.

FIG. 2.0 illustrates the start of the offer acceptance model communication—step (1).

The communication is initiated as the service requestor submits a service request using the application used for communication with the server.

FIG. 3.0 illustrates step (2) as the service request from the service requestor 100 is received via the wireless communication network or internet 300, the request is received by the receiver 203 module.

Receiver 203 module upon receiving the initial request from the service requestor 100 initiates a thread of offer acceptance model.

All communications related to this request are handled by this thread of communication. Communication thread information is persisted in the database 201 as needed.

Additionally, it illustrates the service request processing, including generation of list of potential service providers ordered to increase possibility of acceptance and deeper discounts for the service requestor.

Transmitter 204 module will communicate the service request to the potential service providers via internet to the service providers mobile devices.

FIG. 4.0 illustrates step (3), that is, service request is transmitted to the identified, potential service providers.

Transmitter 204, sends the communicated to the selected service providers 400. As the service providers get the notification regarding the service request, each service provider has the option to respond with accept or ignore service request.

When accepting the service request, additionally the service provider has the option to offer discounts for their services.

FIG. 5.0 illustrates step (4), the response from potential service providers with their offers and discounts in response to the service request.

Mobile devices used by service providers communicate the offers and discounts to the server 200.

All communications to the server 200 is received by the receiver 203 module.

All offers and discounts received from the service providers against a service request are accumulated, and prepared for further communication to the service requestor.

FIG. 6.0 illustrates the step (5), the communication of the responses from the service providers to the service requestor.

This communication carries the details of offer, including any/all discounts offered by the service providers for the service request.

FIG. 7.0 illustrate the step (6), the communication of the response from the server to the service requestor 100.

This is an accumulated response of at least 3 service providers.

At this point the service requestor has the option to cancel the request or accept one of the offers for service.

FIG. 8.0 illustrates the step (7), the communication of the response from the service requestor 100 back to the server 200 via the network communication that includes the internet 300.

The response from the service requestor will be cancelling the original service request if they are no longer interested in the service request, or if none of the offers from the service providers are acceptable.

Service requestor has the option to accept any of the offers presented to them with discounts from service providers.

The acceptance of the offer will complete the offer acceptance model, and an agreement is formed.

FIG. 9.0 illustrates the step (8), the receipt of the communication from service requestor 100 in response to the offers presented by the service providers 400.

If the communication from service requestor 100 indicates cancellation of the request, the entire communication thread is deleted, and the information about the request and incomplete transaction is stored in the database 201.

FIG. 10.0 illustrates the final step (9), if the service requestor 100 accepts any of the presented offers from the service providers 400, the offer acceptance model is completed, and final communication with instructions for service execution is transmitted to the service provider.

What is claimed is:

1. An apparatus for creating an artificial intelligence agent that will serve the offer/acceptance model comprising:
memory storing instructions for receiving the request from service requestor; and
a processor programmed for:
determining the set of service providers that can potentially service the request from the service requestor using various preset criteria for selection and the order of offer going out to the service providers.
directing an application server to create the AI servicing agent, based on the stored parameters about the service requestor, and at least one service elasticity threshold associated with the potential service providers and generate a paradigm to have the service provider ability to offer discounts for the requested service.
Generated list of service providers will receive the details of the service request, with the ability to respond for service and any/all discounts they can offer in order to gain the acceptance from service requestor.
Presenting the offer for service with any/all discounts offered by service providers to service requestor.
Ability for the service requestor to accept one of the offers, and communicate the final connection between service provider and service requestor.

2. The apparatus of claim 1, wherein the parameters of service request comprise of specifications such as the location of requestor, location of the destination and urgency of service.

3. The apparatus of claim 1, where in the application server comprises a server side processor operable for:
receiving the request of service, from the service requestor using a mobile device;
accessing the details of the request in terms of locations and urgency of service;
determining the at least one elasticity threshold associated with the at least one of the parameters of service;
generating list of potential service providers using the artificial intelligence servicing agent using the past data points for the service;
transmit the offer of service with any/all discounts to the service requestor;
transmit the acceptance of offer from the requestor to the service provider via the mediating server;

4. The apparatus of claim 3, wherein the device of the service requestor comprises at least number of a group comprising a smart phone, a mobile tablet, a virtual reality device, or a wearable electronic device.

5. The apparatus of claim 3, wherein the device of the potential service providers comprises at least number of a group comprising a smart phone, a mobile tablet, a virtual reality device, or a wearable electronic device.

6. The apparatus of claim 1, wherein the at least one service request elasticity threshold comprises an allowable deviation associated with the at least one of the service request parameters.

7. The apparatus of claim 1, wherein the discounted offer from the potential service providers are presented to the service requestor with an option to accept the service.

8. A method for creating and managing a offer/acceptance model artificial intelligence (AI) agent, the method comprising:
receiving, from a service requestor device over a network, a request for service with one or more service parameters defined by the requestor;
creating, on one or more application servers, the offer/acceptance model artificial intelligence (AI) for locating the potential service providers at terms complying with the service request parameters of the service requestor;
designating service requestor elasticity thresholds associated with the service request;
locating a plurality of potential service providers using the AI offer/acceptance model—offering the service based on the service parameters;
receiving a plurality of discounted offers from the one or more service providers; and
transmitting the plurality of discounted service offers to a device of service requestor.

9. The method of claim 8, further comprising:
receiving a service details of the service requestor;
receiving an acceptance of the service requestor of at least one of the discounted offers for the service;
communicating the acceptance of the at least one of the discounted offers to the offer/acceptance model AI agent.

10. The method of claim 9, wherein the service request details comprises at least one member of a group comprising of current location, and the final location.

11. The method of claim 8, wherein the at least one discounted offer is based, at least in part, a user profile data of the service requestor;

12. One or more computer-storage memories embodied with executable instructions, comprising:
the offer/acceptance model agent received one or more discounted offer of the service, and put together the communication for the service requestor;
Wherein the Offer/acceptance agent is operable for:
analyzing the service request, calculating the pricing for service using the service request details, and statistics from historical service information from the requestor and potential service providers;
adjusting offer terms offered to the service requestor based of the service.

13. The one or more computer-storage memories of claim 12, wherein the offer/acceptance model is further operable for:
monitoring all discounted offers, and terms of the at least one service provider responding for the service requestor;
as offer for service is accepted, the final agreement and terms are stored and are used for service provided.

14. As the service requestor accepts an offer of discounted offer from the service provider, an agreement is formed, and service provider is communicated to execute on the service request.
